(19) United States
(12) Patent Application Publication
(10) Pub. No.: US 2024/0185458 A1
(43) Pub. Date: Jun. 6, 2024

(54) OBJECT DISTANCE DETECTING DEVICE

(71) Applicant: HITACHI ASTEMO, LTD., Hitachinaka-shi, Ibaraki (JP)

(72) Inventors: Hirotomo SAI, Hitachinaka-shi, Ibaraki (JP); Kota IRIE, Hitachinaka-shi, Ibaraki (JP); Takakiyo YASUKAWA, Hitachinaka-shi, Ibaraki (JP)

(73) Assignee: HITACHI ASTEMO, LTD., Hitachinaka-shi, Ibaraki (JP)

(21) Appl. No.: 18/552,722

(22) PCT Filed: Feb. 15, 2022
(86) PCT No.: PCT/JP2022/005990

§ 371 Date: Sep. 27, 2023

(30) Foreign Application Priority Data
Aug. 24, 2021 (JP) 2021-136687

(51) Int. Cl. G06T 7/73

(52) U.S. Cl. CPC G06T 7/74; G06T 2207/30252

(57) ABSTRACT

An object distance detecting device includes: three imaging sections 101-1, 101-2, and 101-3 which image a same target object; a target object region specifying section 102 which specifies a region, in which the target object exists, on the basis of an image acquired from at least one of the imaging sections; an image selection section 103 which selects one base line direction among a plurality of base line directions defined by any two imaging sections among the imaging sections on the basis of an image of the region specified by the target object region specifying section 102, and selects an image of the region acquired from each of the two imaging sections defining the selected base line direction; and a distance detection section 104 which detects a distance to the target object existing in the region on the basis of the image selected by the image selection section.

### TECHNICAL FIELD

The present invention relates to an object distance detecting device.

### BACKGROUND ART

As a technology of measuring a distance of an object in a three-dimensional space, there is stereo image processing of measuring a distance from images captured by two imaging devices by using the principle of triangulation.

For example, PTL 1 discloses a conventional technology of stereo image processing. The publication describes “there is the possibility that distance measurements may not be temporarily made while the camera is cleaned or the wiper is driven. The present technology is proposed in view of the above circumstances, and an object thereof is to suppress a decrease in reliability of distance measurements”. Further, as a solution therefor, a technique is disclosed in which “an information processing apparatus according to one aspect of the present technology is an information processing apparatus including: a selection section that selects two imaging sections, which perform imaging for generating distance information, from three or more imaging sections configuring an imaging unit; and a distance detection section that detects a distance to an observation point on the basis of images captured by the two selected imaging sections” and “the selection section can select the imaging section on the basis of an operation of a configuration that affects the captured image”.

### CITATION LIST

### Patent Literature

PTL 1: JP 2018-32986 A

### SUMMARY OF INVENTION

### Technical Problem

In the above-described stereo image processing, a base line which is one side of a triangle serving as a reference of triangulation is a line connecting two imaging sections. When an arbitrary point of a target object on the image captured by one imaging section of the two imaging sections and the same point of the same object on the image captured by the other imaging section have a parallel relationship with respect to the base line, the object has only a line parallel to the base line. This means that the object has few spatial frequency components in a direction parallel to the base line.

As described above, in a case where the object has almost no spatial frequency component in the direction parallel to the base line and has many spatial frequency components in a direction perpendicular thereto, it becomes difficult to accurately the object corresponding points on two images, and a correct three-dimensional position cannot be measured. That is, an object having many spatial frequency components of an image perpendicular to the base line has few corresponding points at which the distance can be measured, and the distance cannot be measured accurately.

In PTL 1, the imaging section that measures a distance is selected on the basis of the operation of the configuration that affects the captured image while the camera is cleaned or the wiper is driven, and it is not possible to accurately measure the distance of the object having many spatial frequency components of the image perpendicular to the base line.

### Solution to Problem

In order to solve the above object, the configuration described in the claims is adopted. For example, an object distance detecting device of the present invention is an object distance detecting device which detects a distance to a target object around a vehicle, the device including: at least three imaging sections which image a same target object; a target object region specifying section which specifies a region, in which the target object exists, on the basis of an image acquired from at least one of the imaging sections; an image selection section which selects one base line direction among a plurality of base line directions defined by any two imaging sections among the three or more imaging sections on the basis of an image of the region specified by the target object region specifying section, and selects an image of the region acquired from each of the two imaging sections defining the selected base line direction; and a distance detection section which detects a distance to the target object existing in the region on the basis of the image selected by the image selection section.

### Advantageous Effects of Invention

According to the present invention, it is possible to accurately measure the distance regardless of the spatial frequency components of the image of the object. Further features related to the present invention will become apparent from the description of the present description and the accompanying drawings. In addition, problems, configurations, and effects other than those described above will become apparent from the description of the following embodiments.

### BRIEF DESCRIPTION OF DRAWINGS

FIG. 1 is a diagram illustrating a basic configuration of an object distance detecting device according to a first embodiment.

FIG. 2 is a diagram illustrating a configuration of a target object region specifying section according to the first embodiment.

FIG. 3 is a diagram illustrating a configuration of an image selection section according to the first embodiment.

FIG. 4 is a diagram illustrating a principle of a stereo camera.

FIG. 5A is a diagram illustrating a basic configuration of the object distance detecting device according to a second embodiment.

FIG. 5B is a diagram illustrating the basic configuration of the object distance detecting device according to the second embodiment.

FIG. 6 is a diagram illustrating a basic configuration of the object distance detecting device according to a third embodiment.

FIG. 7 is a diagram illustrating a positional relationship of an imaging section used in the object distance detecting device according to the present invention.

### DESCRIPTION OF EMBODIMENTS

Embodiments of the present invention will be described below with reference to the drawings.

### First Embodiment

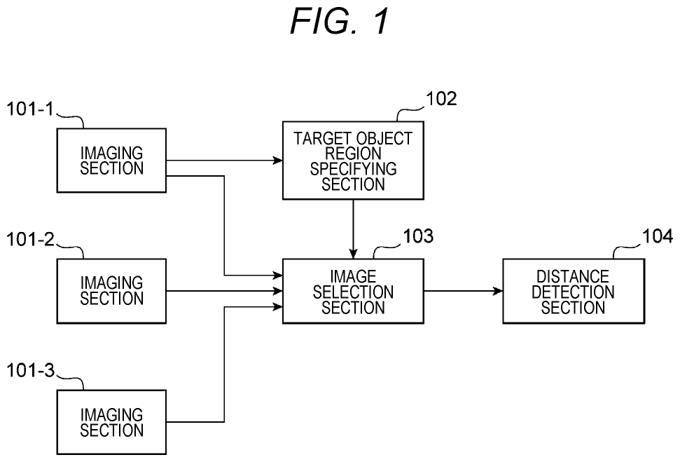

FIG. 1 is a diagram illustrating a basic configuration of an object distance detecting device according to a first embodiment. In FIG. 1, reference numerals 101-1, 101-2, and 101-3 denote imaging sections, 102 denotes a target object region specifying section, 103 denotes an image selection section, and 104 denotes a distance detection section.

In the object distance detecting device illustrated in FIG. 1, the imaging section 101-1, the imaging section 101-2, and the imaging section 101-3 are configured by appropriately using a lens group such as a focus lens, an iris, a shutter, an imaging element such as a CCD or a CMOS, a CDS, an AGC, an AD converter, and the like. Then, the optical image received by the imaging element is photoelectrically converted on the basis of exposure conditions such as the aperture of the iris, the accumulation time of the sensor, the shutter speed, and the gain amount of AGC. The obtained image signal is subjected to various camera image processing such as digital gain processing, demosaicing processing, luminance signal generation processing, and noise correction processing, and is output as a video signal. The video signal from one imaging section 101-1 is transmitted to the target object region specifying section 102, and the video signals from all the imaging sections 101-1, 101-2, and 101-3 are transmitted to the image selection section 103. Note that, although the number of imaging sections is three in the present embodiment, four or more imaging sections may be used.

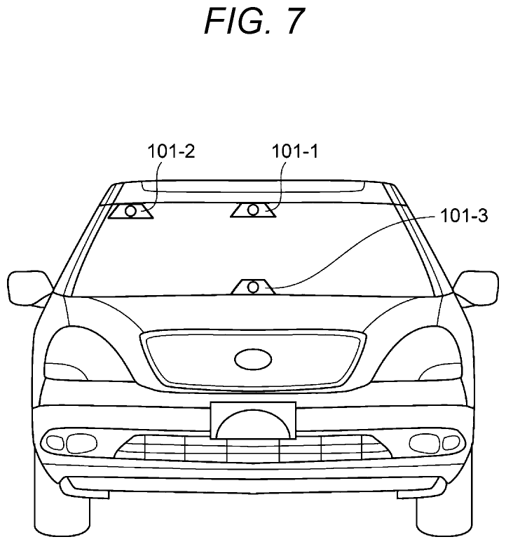

Note that FIG. 7 illustrates an example of a positional relationship among the imaging sections 101-1, 101-2, and 101-3 used in the object distance detecting device according to the present embodiment. In the imaging sections 101-1, 101-2, and 101-3 according to the present embodiment, as illustrated in FIG. 7, the imaging section 101-1 is arranged near the center of the front surface of a vehicle, the imaging section 101-2 has a horizontal relationship with the imaging section 101-1, and the imaging section 101-3 has a vertical relationship with the imaging section 101-1.

This is an example of the number and positional relationship of the imaging sections, and in a case where the number of the imaging sections is, for example, four, an arbitrary positional relationship such as arrangement in which the imaging sections are positioned at vertices of a square can be taken. In addition, FIG. 7 illustrates a case where the imaging sections are arranged on the front surface of the vehicle, but the present invention is not limited thereto, and the imaging section can be arranged on a side surface or a rear surface of the vehicle, and the same applies to other embodiments.

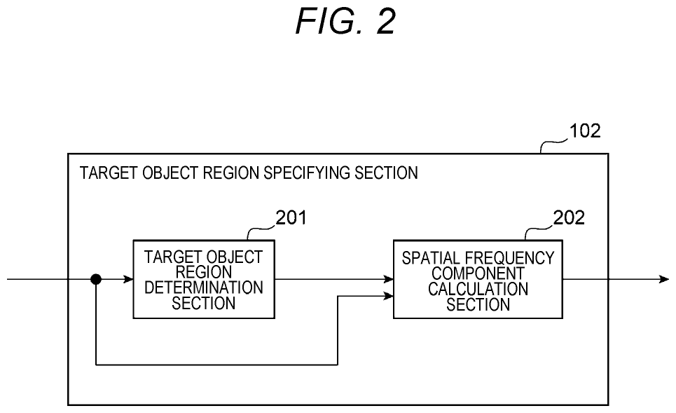

The configuration and operation of the target object region specifying section 102 that receives a video signal from one imaging section 101-1 will be described with reference to FIG. 2. In FIG. 2, reference numeral 201 denotes a target object region determination section, and reference numeral 202 denotes a spatial frequency component calculation section. The target object region determination section 201 receives the video signal from imaging section 101-1, determines in which region of the video signal a desired target object, for example, an object such as a vehicle exists, and outputs the region as data. In a case where there are a plurality of desired target objects such as vehicles in the screen, each of a plurality of regions corresponding to respective target objects is output as data. The spatial frequency component calculation section 202 calculates a spatial frequency component of the data of the region output from the target object region determination section 201 by using filtering processing such as a band pass filter, and outputs the region, the spatial frequency component of the region in the horizontal direction, and the spatial frequency component of the region in the vertical direction to the image selection section 103.

As described above, the target object region specifying section 102 specifies the region where a target object exists and calculates a spatial frequency component for each specified region, and does not measure a distance to the target object. Therefore, the number of video signals input to the target object region specifying section 102 is not necessarily plural. However, a plurality of video signals may be input from a plurality of imaging sections. In this case, for example, an effect that a blind spot region of a certain imaging section can be compensated by another imaging section can be expected. In addition, in the present embodiment, as illustrated in FIG. 7, the imaging section 101-1 defines the horizontal/vertical direction with the other imaging sections 101-2 and 101-3, and thus, the image captured by the imaging section 101-1 is input as a reference to the target object region specifying section 102.

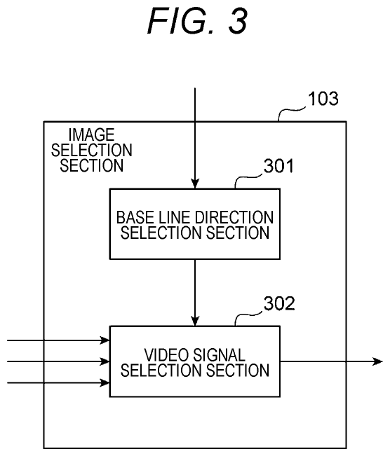

The configuration and operation of the image selection section 103 that receives the video signals from all the imaging sections 101-1, 101-2, and 101-3 and the spatial frequency component calculated by the target object region specifying section 102 will be described with reference to FIG. 3. In FIG. 3, reference numeral 301 denotes a base line direction selection section, and reference numeral 302 denotes a video signal selection section. The base line direction selection section 301 receives the spatial frequency component for each region calculated by the target object region specifying section 102, and outputs, as the base line direction to be selected for each region, the horizontal direction when the spatial frequency component in the horizontal direction is large and the vertical direction when the spatial frequency component in the vertical direction is large, to the video signal selection section 302.

For each region specified by the target object region specifying section 102, the video signal selection section 302 selects the imaging section that defines the base line direction horizontal to the imaging section 101-1 when the base line direction received from the base line direction selection section 301 is the horizontal direction, and the video signal selection section 302 selects the imaging section that defines the base line direction vertical to the imaging section 101-1 when the received base line direction is the vertical direction. In the present embodiment, the imaging device has three configurations. However, even in a case where there are four or more configurations, if the base line direction received from the base line direction selection section 301 is the horizontal direction, a video signal of an arbitrary imaging section that defines the base line direction horizontal to the imaging section 101-1 is selected for each region, and if the received base line direction is vertical, a video signal of an arbitrary imaging section that defines the base line direction vertical to the imaging section 101-1 is selected for each region.

In the object distance detecting device illustrated in FIG. 1, the distance detection section 104 calculates the distance to the target object in the video signal from the two video signals of each region selected by the image selection section 103.

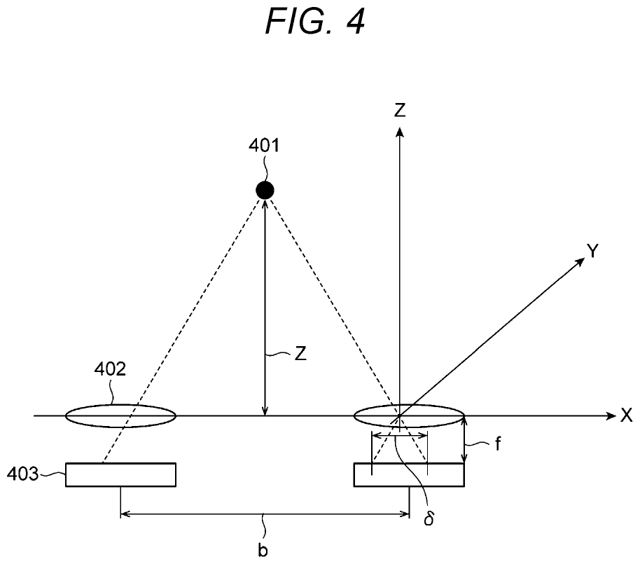

The operation of the distance detection section 104 will be described with reference to FIG. 4. FIG. 4 is a diagram illustrating a general principle of a stereo camera used for measuring a distance of an object in a three-dimensional space. In FIG. 4, reference numeral 401 denotes a measurement point, reference numeral 402 denotes a lens, reference numeral 403 denotes an imaging surface, reference numeral δ denotes parallax, reference numeral Z denotes a measurement distance (a distance from the lens 402 to the measurement point 401), reference numeral f denotes a focal length (a distance from the imaging surface 403 to the lens 402), and reference numeral b denotes a base line length (a length between two imaging elements). The measurement distance Z is calculated by an equation expressed by the following Formula 1.

[Formula 1]

Z=bf/δ (Formula 1)

According to the present embodiment, for each region where an object to be recognized exists, the spatial frequency component in the horizontal direction and the spatial frequency component in the vertical direction of the image of the region are calculated. Then, for each region, video signals of a combination of imaging sections that defines a base line direction in the direction with more spatial frequency components are selected. That is, for example, for a region where a target object, such as a person or a car, which has many spatial frequency components in the horizontal direction is present, a combination of imaging sections that defines the horizontal direction is selected from the plurality of imaging sections, and for a region where a target object, such as a falling object or a recess on a road, which has many spatial frequency components in the vertical direction is present, a combination of imaging sections that defines the vertical direction is selected from the plurality of imaging sections. Therefore, it is possible to select the imaging section that defines the base line direction in which more corresponding points necessary for three-dimensional distance measurement can be acquired for the target object, and to accurately measure the distance to the desired object.

### Second Embodiment

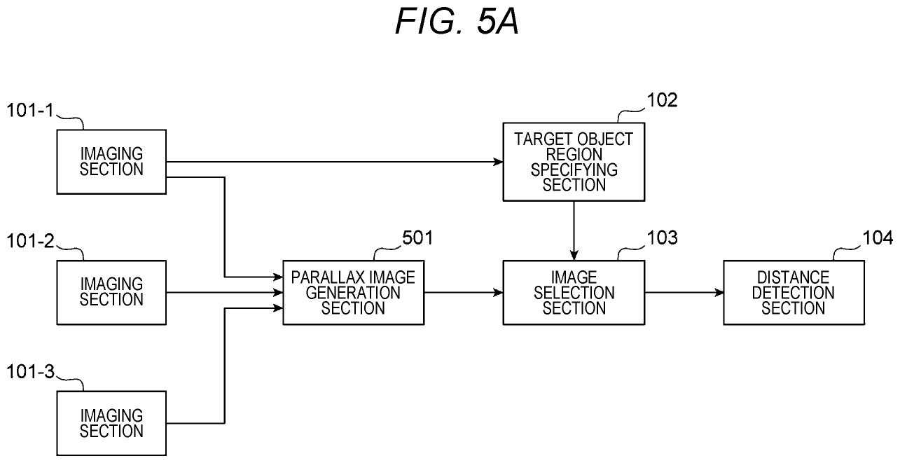

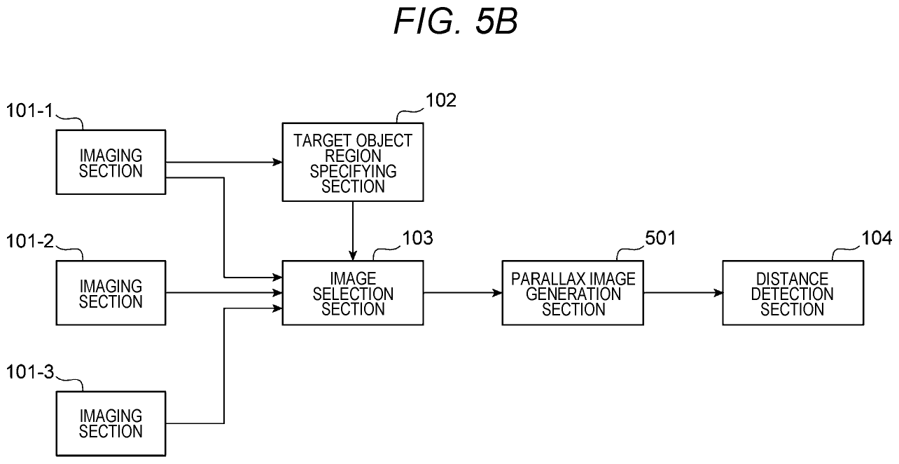

Next, the object distance detecting device according to a second embodiment of the present invention will be described with reference to FIGS. 5A and 5B. Note that portions already described in the first embodiment are denoted by the same reference numerals, and redundant description will be omitted. The same applies to a third embodiment.

The object distance detection section according to the second embodiment is different from the first embodiment in further including a parallax image generation section 501. In FIG. 5A, the parallax image generation section 501 receives the video signals generated by three imaging sections 101-1, 101-2, and 101-3. Then, a parallax δ expressed by Formula 1 of the first embodiment is calculated as a parallax image generated from the video signals output from the imaging section 101-1 and the imaging section 101-2 and a parallax image generated from video signals output from the imaging section 101-1 and the imaging section 101-3, and the parallax images are output to the image selection section 103.

In the image selection section 103, the parallax image output from the parallax image generation section 501 is input to the video signal selection section 302, and if the base line direction received from the base line direction selection section 301 is the horizontal direction, the parallax image generated with the imaging section that defines the base line direction horizontal to the imaging section 101-1 is selected for each region, and if the received base line direction is the vertical direction, the parallax image generated with the imaging section that defines the base line direction vertical to the imaging section 101-1 is selected for each region.

Then, the distance detection section 104 calculates distances of a plurality of target objects in the video signal from the parallax image for each region selected by the image selection section 103 by using the above Formula 1.

Note that in FIG. 5A, the parallax image generation section 501 is arranged between three imaging sections 101-1, 101-2, and 101-3 and the image selection section 103, and generates a parallax image on the basis of the video signals output from the three imaging sections. However, as illustrated in FIG. 5B, the parallax image generation section 501 may be arranged between the image selection section 103 and the distance detection section 104.

In this case, the parallax image generation section 501 generates the parallax image on the basis of the video signal output from the image selection section 103 through the process described in the first embodiment. Then, the distance detection section 104 detects the distance to the target object on the basis of the generated parallax image.

According to the present embodiment, for each region of the object to be recognized, according to the spatial frequency component in the horizontal direction and the spatial frequency component in the vertical direction of the image of the region, the parallax image by the combination of the imaging sections that define the base line direction in the direction with more spatial frequency components is selected. Therefore, many corresponding points for measuring the distance to the target object can be obtained, and thus the obtained parallax image becomes clearer, and the distance to the desired object can be measured with high accuracy.

### Third Embodiment

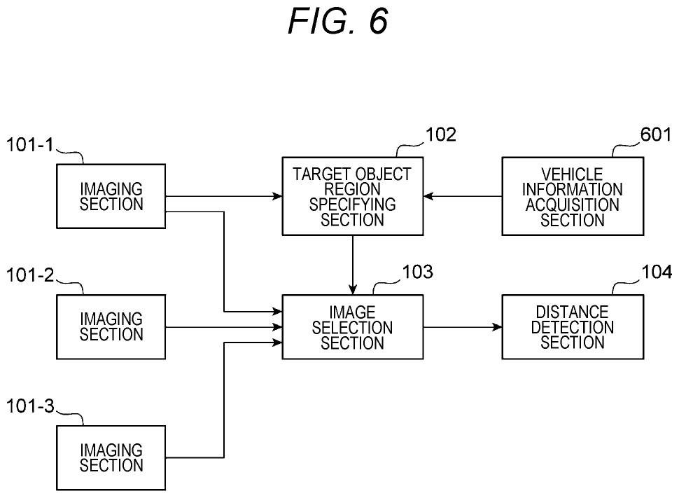

Next, an object distance detecting device according to the third embodiment of the present invention will be described with reference to FIG. 6. The object distance detection section according to the third embodiment is different from the first embodiment in including a vehicle information acquisition section 601. The vehicle information acquisition section 601 includes various sensors such as a vehicle speed sensor that detects the speed of a host vehicle, a steering angle sensor that detects the steering angle of a steering wheel, and a GPS that acquires position information of the host vehicle. Then, various types of information acquired by the vehicle information acquisition section 601 are output to the target object region specifying section 102.

In the present embodiment, the spatial frequency component calculation section 202 in the target object region specifying section 102 weights the values of the spatial frequency components in the horizontal direction and the vertical direction calculated for the image according to the vehicle speed, the steering angle of the steering wheel, and the like. For example, in a case where the vehicle is traveling at a low speed and the steering angle of the steering wheel is turned by a certain angle or more, it can be determined that the vehicle is traveling in an intersection on a general road. In such a case, the target object to be recognized is a target object, such as a pedestrian or another vehicle, which has many spatial frequency components of an image in the horizontal direction. Therefore, the spatial frequency component of the image in the horizontal direction is multiplied by a certain numerical value such that the spatial frequency component of the image in the vertical direction takes a minimum value or the spatial frequency component of the image in the horizontal direction is maximized.

For example, if the host vehicle is traveling at a high speed and the steering angle of the steering wheel is equal to or less than a certain angle, it can be determined that the host vehicle is traveling on an expressway. In such a case, the target object to be recognized is a target object, such as a falling object or a recess on a road, which has many spatial frequency components of the image in the vertical direction. Therefore, the spatial frequency component of the image in the vertical direction is multiplied by a certain numerical value such that the spatial frequency component of the image in the horizontal direction takes a minimum value or the spatial frequency component of the image in the vertical direction is maximized.

In the present embodiment, the vehicle speed, the steering angle of the steering wheel, and the position information are exemplified as the vehicle information, but road information such as an intersection and an expressway may be included from map information and host vehicle position information.

According to the present embodiment, according to the spatial frequency component in the horizontal direction and the spatial frequency component in the vertical direction of the image of each region where the object to be recognized exists, and the vehicle information such as the vehicle speed and the steering angle of the steering wheel, an appropriate video signal of the imaging section can be selected according to the control and traveling state of the vehicle, and the distance of the desired object can be measured with high accuracy.

According to the embodiment of the present invention described above, the following operational effects are exhibited.

(1) An object distance detecting device includes: at least three imaging sections 101-1, 101-2, and 101-3 which image a same target object; a target object region specifying section 102 which specifies a region, in which the target object exists, on the basis of an image acquired from at least one of the imaging sections; an image selection section 103 which selects one base line direction among a plurality of base line directions defined by any two imaging sections among the imaging sections on the basis of an image of the region specified by the target object region specifying section 102, and selects an image of the region acquired from each of the two imaging sections defining the selected base line direction; and a distance detection section 104 which detects a distance to the target object existing in the region on the basis of the image selected by the image selection section 103.

As a result, it is possible to optimize the combination of the imaging sections so as to obtain many corresponding points necessary for three-dimensional distance measurement on the basis of the property of the imaging target object, and thus, it is possible to realize distance detection with excellent accuracy.

(2) The target object region specifying section 102 obtains a spatial frequency component in a vertical direction and a spatial frequency component in a horizontal direction of the image of the region, and the image selection section 103 selects the base line direction on the basis of the obtained spatial frequency component in the vertical direction and the obtained spatial frequency component in the horizontal direction. Therefore, it is possible to select the combination of the imaging sections so as to obtain many corresponding points necessary for three-dimensional distance measurement for each region in which the target object having many spatial frequency components in the horizontal/vertical directions exists, and it is possible to realize distance detection with more excellent accuracy.

(3) The object distance detecting device further includes a parallax image generation section 501 which generates a parallax image of the region from the image selected by the image selection section 103, and the distance detection section 104 detects the distance to the target object on the basis of the parallax image. Alternatively, the object distance detecting device further includes a parallax image generation section 501 which generates a plurality of parallax images from the image acquired from each of the three or more imaging sections, the image selection section 103 selects the parallax image generated from the image acquired from each of the two imaging sections defining the selected base line direction, and the distance detection section 104 detects the distance to the target object on the basis of the parallax image selected by the image selection section 103. As a result, since the distance detection using the known parallax image is performed, it is possible to provide a distance detection method from various angles.

(4) The object distance detecting device further includes a vehicle information acquisition section which acquires vehicle information of at least one of motion state information or position information of the vehicle, the vehicle information acquisition section obtains a spatial frequency component in a vertical direction and a spatial frequency component in a horizontal direction of image data of the region by weighting based on the vehicle information, and the image selection section selects the base line direction on the basis of the spatial frequency component in the vertical direction and the spatial frequency component in the horizontal direction obtained by weighting. Therefore, for example, adjustment can be made so as to easily detect a distance to a person or another vehicle when it is determined that the vehicle is traveling in an intersection on a general road and to easily detect a distance to a falling object, a recess on a road, or the like when it is determined that the vehicle is traveling on an expressway. Therefore, it is possible to perform appropriate distance measurement according to the situation.

(5) In a case where there is a plurality of regions where a target object exists, the image selection section 103 selects the base line direction for each of the regions. As a result, even in a case where there is a plurality of imaging target objects, it is possible to distinguish each target object and perform appropriate distance measurement.

(6) The image selection section selects the vertical direction as the base line direction when the number of the spatial frequency components in the vertical direction obtained by the target object region specifying section is large, and selects the horizontal direction as the base line direction when the number of the spatial frequency components in the horizontal direction is large. That is, for a region where a target object having many spatial frequency components in the horizontal direction is present, a combination of imaging sections that defines the horizontal base line direction is selected from the plurality of imaging sections, and for a region where a target object having many spatial frequency components in the vertical direction is present, a combination of imaging sections that defines the vertical base line direction is selected from the plurality of imaging sections. Therefore, it is possible to select the imaging section that defines the base line direction in which more corresponding points necessary for three-dimensional distance measurement can be acquired for the target object, so that more accurate distance detection can be realized.

Note that the present invention is not limited to the above-described embodiments, and various design changes can be made without departing from the spirit of the present invention described in the claims. For example, the above-described embodiments have been described in detail in order to help understanding of the present invention, and are not necessarily limited to those having all the described configurations. In addition, a part of the configuration of a certain embodiment can be replaced with the configuration of another embodiment, and the configuration of another embodiment can be added to the configuration of a certain embodiment. It is possible to add, delete, and replace other configurations for a part of the configuration of each embodiment.

### REFERENCE SIGNS LIST

101-1, 101-2, 101-3 imaging section
102 target object region specifying section
103 image selection section
104 distance detection section
501 parallax image generation section
601 vehicle information acquisition section

1. An object distance detecting device which detects a distance to a target object around a vehicle, the device comprising:
at least three imaging sections which image a same target object;
a target object region specifying section which specifies a region, in which the target object exists, on a basis of an image acquired from at least one of the imaging sections;
an image selection section which selects one base line direction among a plurality of base line directions defined by any two imaging sections among the three or more imaging sections on a basis of an image of the region specified by the target object region specifying section, and selects an image of the region acquired from each of the two imaging sections defining the selected base line direction; and
a distance detection section which detects a distance to the target object existing in the region on a basis of the image selected by the image selection section.

2. The object distance detecting device according to claim 1, wherein
the target object region specifying section obtains a spatial frequency component in a vertical direction and a spatial frequency component in a horizontal direction of the image of the region, and
the image selection section selects the base line direction on a basis of the obtained spatial frequency component in the vertical direction and the obtained spatial frequency component in the horizontal direction.

3. The object distance detecting device according to claim 1, further comprising:
a parallax image generation section which generates a plurality of parallax images from the image acquired from each of the three or more imaging sections, wherein
the image selection section selects the parallax image generated from the image acquired from each of the two imaging sections defining the selected base line direction, and
the distance detection section detects the distance to the target object on a basis of the parallax image selected by the image selection section.

4. The object distance detecting device according to claim 1, further comprising:
a parallax image generation section which generates a parallax image of the region from the image selected by the image selection section, wherein
the distance detection section detects the distance to the target object on a basis of the parallax image.

5. The object distance detecting device according to claim 1, further comprising:
a vehicle information acquisition section which acquires vehicle information of at least one of motion state information or position information of the vehicle, wherein
the vehicle information acquisition section obtains a spatial frequency component in a vertical direction and a spatial frequency component in a horizontal direction of image data of the region by weighting based on the vehicle information, and
the image selection section selects the base line direction on a basis of the spatial frequency component in the vertical direction and the spatial frequency component in the horizontal direction obtained by weighting.

6. The object distance detecting device according to claim 1, wherein
in a case where there are a plurality of regions where a target object exists, the image selection section selects the base line direction for each of the regions.

7. The object distance detecting device according to claim 2, wherein
the image selection section selects the vertical direction as the base line direction when the number of the spatial frequency components in the vertical direction obtained by the target object region specifying section is large, and selects the horizontal direction as the base line direction when the number of the spatial frequency components in the horizontal direction is large.
